(19) United States
(12) Patent Application Publication
(10) Pub. No.: US 2017/0098189 A1
(43) Pub. Date: Apr. 6, 2017

(54) SPATIAL CORRECTION TOOL SYSTEM AND METHOD

(71) Applicant: Energy Technologies, LLC, Wichita, KS (US)

(72) Inventors: Mark G. Allen, Wichita, KS (US); James M. Harris, III, Wichita, KS (US)

(73) Assignee: Energy Technologies, LLC, Wichita, KS (US)

(21) Appl. No.: 15/284,384

(22) Filed: Oct. 3, 2016

Related U.S. Application Data
(60) Provisional application No. 62/236,501, filed on Oct. 2, 2015.

(51) Int. Cl. G06Q 10/08; G06F 17/30

(52) U.S. Cl. CPC G06Q 10/0833; G06F 17/30241

(57) ABSTRACT

A method and system for adjusting the spatial accuracy of one or more address records by comparing the situs addresses of parcel records to the physical addresses of the address records, comparing the landowner names of parcel records to the personal names of the address records, and comparing the spatial coordinates of the address record to the spatial coordinates for the centroids of parcel records.

### RELATED APPLICATIONS

This application claims the benefit of a provisional application, application Ser. No. 62/236,501, filed Oct. 2, 2015.

### FIELD OF INVENTION

The present invention relates generally to a system and method for correcting and increasing the spatial accuracy of address points in relationship to their actual location and parcel boundary location.

### BACKGROUND OF THE INVENTION

Geocoding is the process of transforming a description of a location—such as a pair of coordinates, an address, or a name of a place—to a location on the earth's surface. A wide variety of location descriptors can be geocoded including points of interest like mountains, bridges, and stores; coordinates based on latitude and longitude or other reference systems, such as the Military Grid Reference System (MGRS) or the U.S. National Grid system; and addresses, which can come in different styles and formats, including street intersections, house numbers with street names, and postal codes.

Current methods of geocoding involve interpolating the geographic xy coordinates of a location from spatial reference data, which may include street addresses, postal codes, ZIP codes and other Geographic Information System (GIS) data. In such methods, street address ranges are matched to GIS street, block or township data to linearly interpolate the position of the address. FIG. 1 depicts the typical results of such methods where current address points that are linearly interpolated based on the number of the address and its expected position on the street. As shown, the address points fall on the street and not on the actual location or parcel of the address, as shown in FIG. 5. It is understood that improved accuracy is needed for certain applications and that such improvements will assist in all applications.

Accordingly, there is a need for an improved system to correct and increase the accuracy of previously geocoded locations based on the actual location and parcel boundary location of each address. It is to this and other needs that the present embodiments are directed.

### BRIEF DESCRIPTION OF DRAWINGS

FIG. 1 is an illustration of geocoded addresses using current methods.

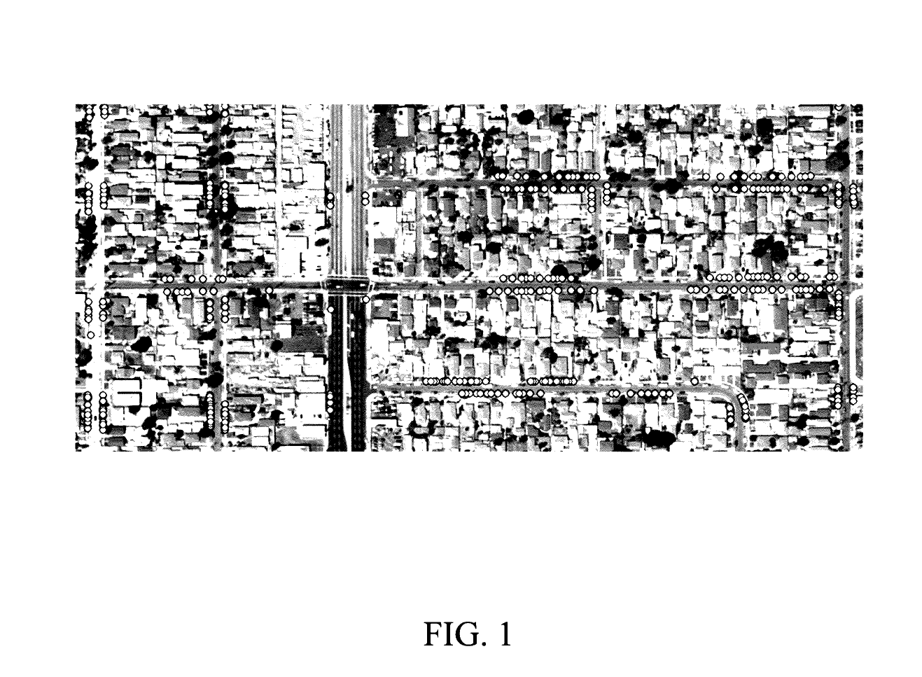

FIG. 2 is a flow chart diagram illustrating steps associated with a preferred embodiment of the spatial correction method.

FIG. 3 is a flow chart diagram illustrating steps associated with a first alternate preferred embodiment of the spatial correction method.

FIG. 4 is a flow chart diagram illustrating steps associated with a second alternate preferred embodiment of the spatial correction method.

FIG. 5 is an illustration of corrected geocoded addresses with the xy coordinates located on the parcel of the address.

### WRITTEN DESCRIPTION

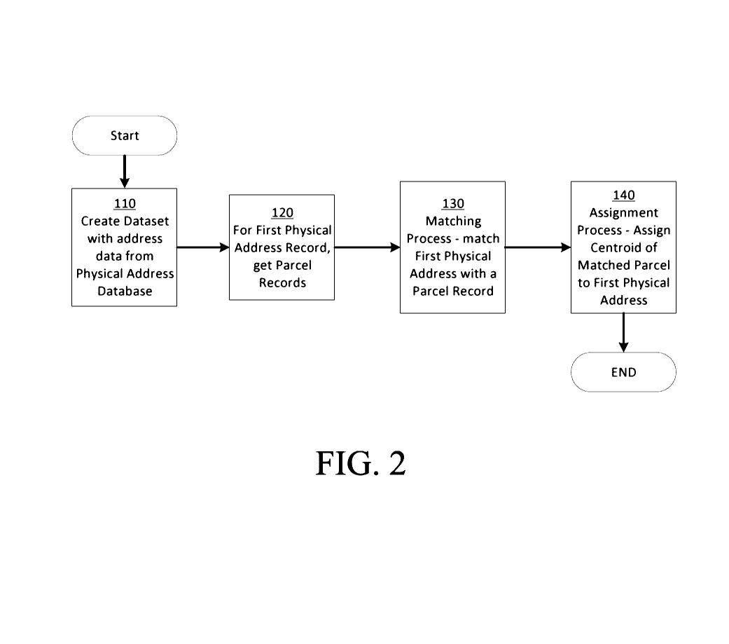

Turning first to FIG. 2, depicted therein is a flow chart illustrating steps associated with a process for correcting geocoded address points. The process begins in step 110, which creates a dataset from a physical address database. In the preferred embodiment, the dataset includes physical addresses from a specified bounded geographic area, e.g., within one square mile. Alternatively, the dataset could be selected from other criteria, such as a range of address numbers, a certain zip code or range of zip codes, or any other desired parameters.

After creating the data set, the process moves to step 120, which requests parcel records from a parcel record database. The requested parcel records are associated with a first physical address from the dataset created in step 110. In the preferred embodiment, the requested parcel records are located within a certain distance of the first physical address, preferably one mile. Alternatively, the requested parcel records could be those associated with a particular address block or other specified area that is associated with the first physical address.

The process then moves to step 130, which matches the first physical address from the dataset created in step 110 with a parcel record from the parcel records obtained in step 120. Then in step 140, the centroid of the matched parcel record is assigned the first physical address.

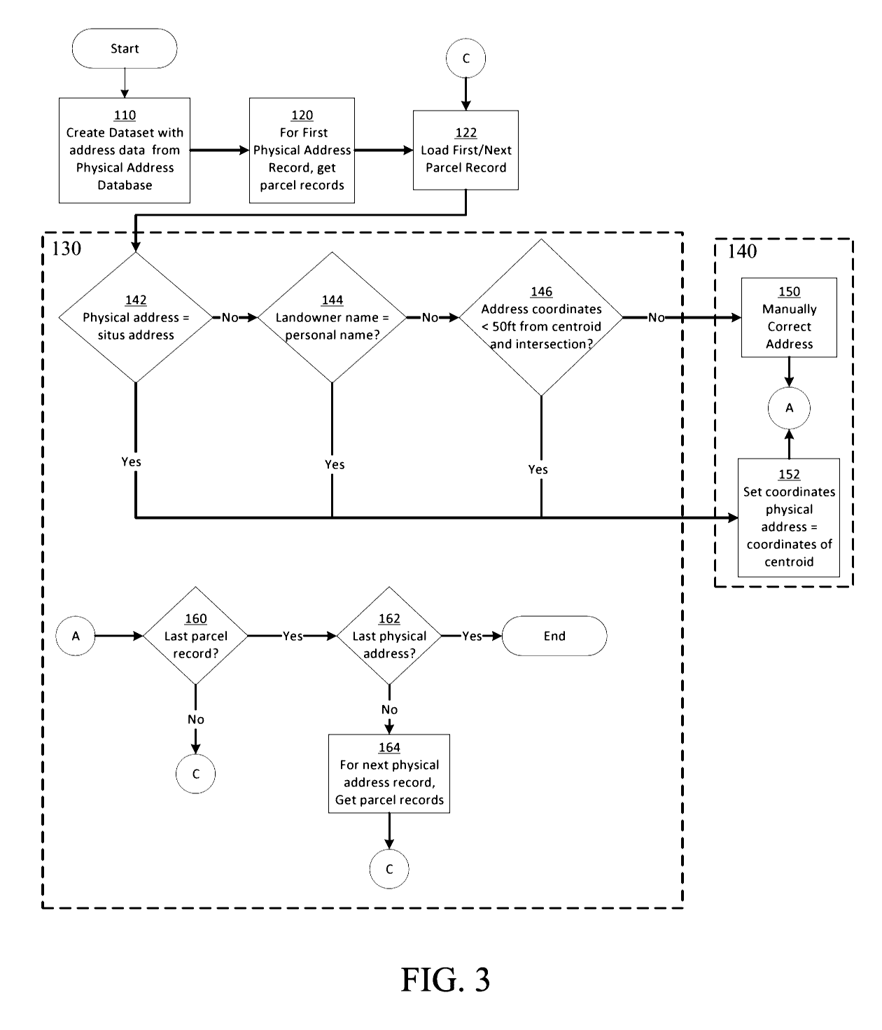

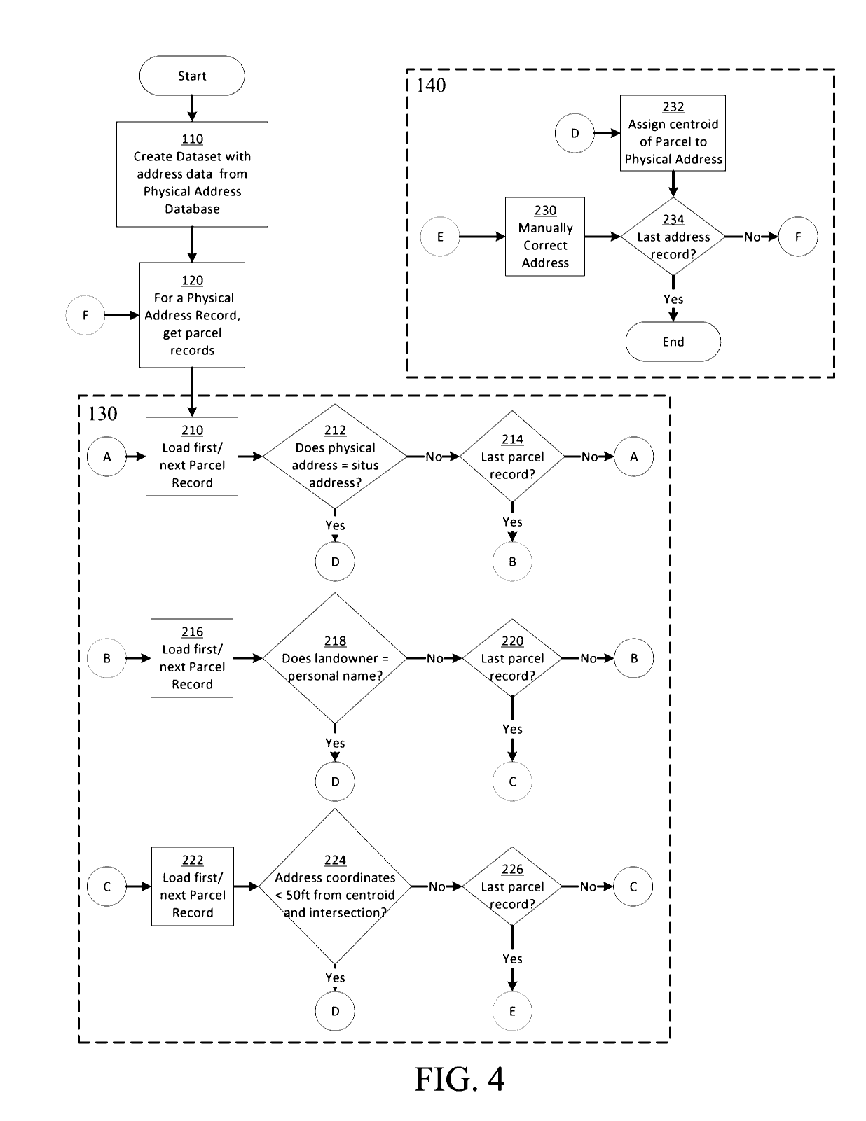

It will be understood that there are a multitude of methods and criteria that could be used to perform step 130. FIGS. 3 and 4 depict two different proffered embodiments.

FIG. 3 depicts a flow chart showing a first embodiment of additional steps associated with the matching process 130 and the assignment process 140 for correcting geocoded address points. In particular, after the process obtains the parcel records in step 120, the process moves to step 122, wherein a single parcel record from the parcel records obtained in step 120 is loaded into the system.

After loading the parcel record, the process performs the testing process of step 130 to match the parcel record to the first physical address by first determining in step 142 whether the first physical address matches the situs data associated with the parcel record. If the physical address and situs data in step 142 do not match, then in step 144 the process determines whether the landowner name from the first parcel record is equal to the name associated with the first physical address. If the names do not match, the process moves to step 146 where the process determines whether the centroid of the parcel record is located with a set distance, such as 50 feet, from the coordinates of the physical address record.

If step 146 determines that the centroid is not within the set distance, then the process moves to step 150 where a manual assignment of the centroid of the parcel record is matched to the first physical address. In the preferred embodiment the manual assignment process in step 150 is performed by manually relocating the address point to the physical location of the physical address and appending a xy coordinate from the interior of the parcel to the physical address so that the address point is located directly over the centroid of the parcel.

In any of the steps 142, 144, or 146, if a match is found, then the process moves to step 152 where the xy coordinates of the physical address are set to equal the coordinates of the centroid of the parcel record so that the address point is located directly over the centroid of the parcel record.

After the first physical address is spatially corrected such that the xy coordinates are located in the center of the parcel through step 150 or step 152, the process moves to step 160, which determines whether the parcel record loaded in step 122 is the last parcel record among the parcel records requested in step 120. If the parcel record is not the last parcel record, the process loops back to step 122 to load in the next parcel record into the system and the process repeats until step 160 determines the parcel record is the last parcel record.

Once the last parcel record is determined, the process moves to step 162 to determine whether the physical address is the last physical address among the data set created in step 110. If the physical address is not the last physical address in the data set, then the process in step 155 obtains the parcel records associated with the next physical address in the data set. The process then loops back through the matching process of 130 and the assignment process of 140 for the next physical address. If the process determines in step 162 that the physical address record is the last physical address, then the process ends.

Now turning to FIG. 4, depicted therein is a flow chart showing alternatively preferred steps associated with the matching process 130 and the assignment process 140 for correcting geocoded address points. In FIG. 4, after the process obtains the parcel records in step 120, the process moves to step 210, wherein the first parcel record from the parcel records obtained in step 120 is loaded into the system.

Then, in step 212, the process determines whether the first physical address matches the situs data associated with that parcel record. If the physical address and situs data of the parcel record do not match, the process moves to step 214 to determine whether the parcel record loaded in step 210 is the last parcel record. If the parcel record is not the last parcel record, it loops back to step 212 and obtains the next parcel record and returns to step 212 to determine whether the new parcel record matches the situs address. This process loop repeats until the process reaches the last parcel record in step 214 or a match is found in step 212.

If the parcel record is found to be the last parcel record in step 214, the process moves to step 216 wherein a parcel record is loaded into the system. The process then moves to step 218 where the process determines whether the landowner name from the first parcel record is equal to the name associated with the physical address. If the names do not match, the process moves to step 220 to determine whether the parcel record loaded in step 216 is the last parcel record. If the parcel record is not the last parcel record, it loops back to step 216 to load the next parcel record and then back to step 218 to determine whether the landowner name or the next parcel record matches the name associated with the physical address. This process repeats until the process reaches the last parcel record in step 220 or a match is found in step 218.

If the parcel record is determined to be the last parcel record in step 220, then the process moves to step 222 where the first parcel record is loaded into the system. Next, in step 224, the process determines whether the centroid of the parcel record is located with a set distance, such as 50 feet, from the coordinates of the physical address record. If step 224 determines that the centroid is not within the set distance, then the process moves to step 226 to determine whether the parcel record loaded in step 222 is the last parcel record. If the parcel record is not the last parcel record, it loops back to step 222 to load in the next parcel record and then moves to step 224 to determine whether the whether the centroid of the next parcel record is located with a set distance from the coordinates of the physical address. This process repeats until the process reaches the last parcel record in step 226 or a match is found in step 224.

If the parcel record is determined to be the last parcel record in step 226, then the process moves to the assignment process 140 and in step 230 the centroid of the parcel record is manually assigned to match the physical address as previously described above in step 150. In any of the steps 212, 218, or 224, if a match is found, then the process moves to step 232 where the xy coordinates of the physical address are assigned to equal the coordinates of the centroid of the parcel record so that the address point is located directly over the centroid of the parcel.

After the first physical address is spatially corrected such that the xy coordinates are located in the center of the parcel in step 230 or step 232, the process moves to step 234 where the process determines whether the physical address matched is the last physical address in the data set created in step 110. If the physical address is not the last physical address, the process moves on to step 120 for the next physical address and repeats the steps described above. If the physical address is the last physical address, the process ends.

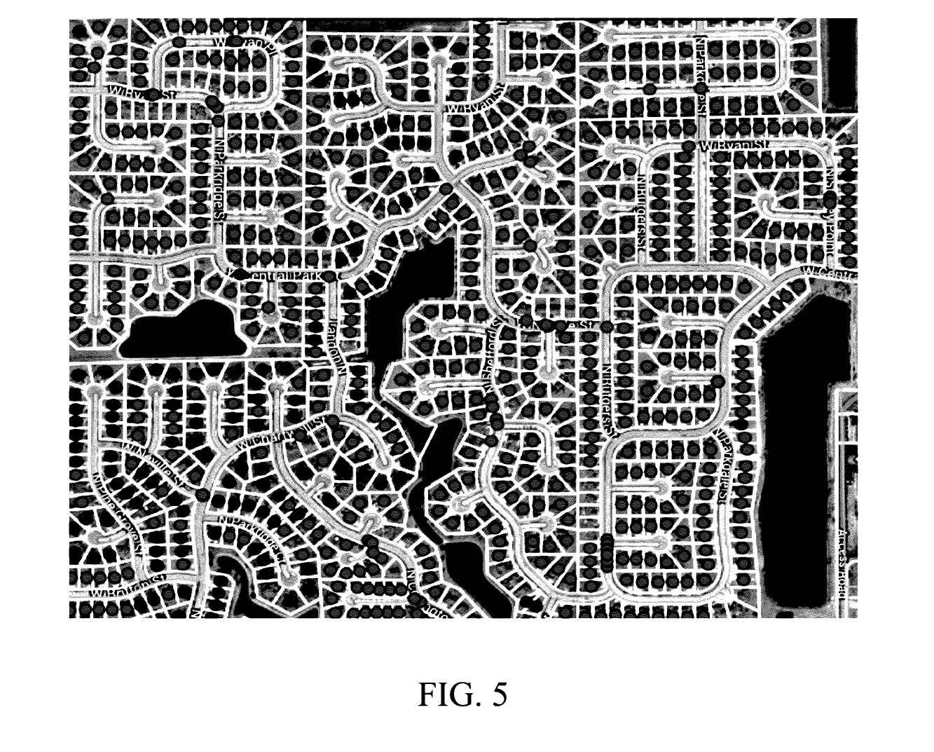

Now referring to FIG. 5, depicted therein is an illustration of address points that are now spatially located from the processes used in FIGS. 2, 3 and 4, such that the xy coordinates fall on the actual physical locations of the centroids of the parcels.

It is clear that the present invention is well adapted to carry out its objectives and attain the ends and advantages mentioned above as well as those inherent therein. While presently preferred embodiments of the invention have been described in varying detail for purposes of disclosure, it will be understood that numerous changes may be made which will readily suggest themselves to those skilled in the art and which are encompassed within the spirit of the invention disclosed herein.

I claim:

1. A method for adjusting the spatial coordinates of a plurality of address records the method comprising:
identifying a plurality of parcel records that correspond to each address record in the plurality of address records;
determining if a situs address of any parcel record in the plurality of parcel records matches a physical address of the corresponding address record in the plurality of address records, and where such a determination is made, assigning the spatial coordinates for the centroid of the matching parcel record to the corresponding address record;
determining if a landowner name of any parcel record in the plurality of parcel records matches a personal name of the corresponding address record, and where such a determination is made, assigning the spatial coordinates for the centroid of the matching parcel record to the corresponding address record; and
determining if the spatial coordinates of the corresponding address record are less than a selected distance from the spatial coordinates for the centroid of any parcel record within the plurality of parcel records, and where such a determination is made, assigning the spatial coordinates for the centroid of such parcel record to the corresponding address record.

2. The method of claim 1, wherein the selected distance is less than 100 feet.

3. The method of claim 2, further comprising the step of manually assigning spatial coordinates on an address record is performed for each address record for which no situs address was determined to match the physical address of the address record, no landowner name of parcel record was determined to match the personal name of the address record, and no spatial coordinates of the centroid of any parcel record were determined to be within the selected distance of the spatial coordinates of the address record.
